(19) United States
(12) Patent Application Publication
(10) Pub. No.: US 2003/0049008 A1
(43) Pub. Date: Mar. 13, 2003

(54) Multi-level fiber transition apparatus

(75) Inventor: Dany M. Zeidan, Howell, NJ (US)

Correspondence Address: John P. Maldjian, TyCom (US) Inc., Rm 2B 106, 250 Industrial Way West, Eatontown, NJ, 07724, US

(73) Assignee: Terra Worx, Inc.

(21) Appl. No.: 09/948,228

(22) Filed: Sep. 7, 2001

(51) Int. Cl. G02B 6/00

(52) U.S. Cl. 385/136; 385/134

(57) ABSTRACT

A fiber transition apparatus is used to transition optical fiber between multiple levels of components in fiber optic equipment. The fiber transition apparatus comprises a helical fiber holding member having a fiber passage for receiving the optical fiber and a shape and dimension to maintain a critical bend radius of the optical fiber. The fiber holding member passes through at least two levels of electronic components, such as two printed wiring boards (PWBs). Optical fiber passes into and out of the fiber holding member at each of the levels. One embodiment of the fiber holding member includes a slot that allows the fibers to pass into and out of the fiber holding member. The fiber holding member is preferably mounted to at least one of the PWBs, for example, using mounting members attached at each end of the fiber holding member.

### TECHNICAL FIELD

The present invention relates to fiber optic equipment and more particularly, to a multi-level fiber transition apparatus for use in transitioning optical fiber between multiple levels of components in the fiber optic equipment.

### BACKGROUND INFORMATION

Optical fiber has become an integral part of telecommunications equipment as a transmission medium. An increasing demand in transmission capacity has increased the need for higher bandwidth and optical fiber density in the telecommunications equipment. As a result of the current higher bandwidth/density requirements, most telecommunications equipment has printed wiring board (PWB) assemblies comprised of several individual boards sandwiched together to create the final assembly with optical fibers passing from each PWB often to one user interface. Examples of the equipment in which this is an issue include optical amplifiers and multiplexers. As a result, a large amount of optical fiber must be managed by transitioning the fiber from one side of each PWB to another side in a “real-estate” efficient manner while maintaining the critical bend radius of the fiber (e.g. about 25-30 mm).

Current practices use large slots in the PWB or plane being traversed and several fiber management devices on both sides of the PWB to permit the transition. This system consumes a relatively large amount of real estate and is labor intensive. Also, existing fiber management devices, such as saddles, provide a localized routing “checkpoint” but the fiber is exposed between the “checkpoints.” Moreover, it is difficult, if not impossible, to transition the fiber to more than two levels using the current techniques, because the fiber in the space between the various levels is not protected along the fiber run.

Accordingly, there is a need for a multi-level fiber transition apparatus capable of transitioning optical fibers through multiple levels in a “real-estate” efficient manner while protecting the fiber and maintaining the critical bend radius substantially along the full fiber run.

### SUMMARY

In accordance with one aspect of the present invention, a multi-level fiber transition apparatus is used to transition optical fiber between multiple levels of components in fiber optic equipment. The apparatus comprises a helical fiber holding member having a fiber passage for receiving the optical fiber and insertion regions spaced along the helical fiber holding member for allowing the optical fibers to pass into and out of the fiber passage. The helical fiber holding member has a shape and dimension to protect and maintain a critical bend radius of the optical fiber. One embodiment of the helical fiber holding member includes a slot extending along at least a portion of the helical fiber holding member and into the fiber passage to form the insertion regions.

At least one mounting member mounts the helical fiber holding member to the fiber optic equipment. Mounting members can be positioned at one or both ends of the helical fiber holding member. The mounting member can be secured to the helical fiber holding member or one-piece with the helical fiber holding member.

In accordance with another aspect of the present invention, a fiber transition system comprises optical fiber, a helical fiber holding member, and multiple levels of electronic components. The helical fiber holding member passes through at least two of the multiple levels and the insertion regions in the helical fiber holding member are located proximate at least two of the multiple levels. The optical fiber passes through the insertion regions in the helical fiber holding member to the electronic components at the respective levels.

In one embodiment, multiple printed wiring boards form the multiple levels. At least some of the multiple printed wiring boards include a hole for receiving the helical fiber holding member. In another embodiment, a single printed wiring board includes higher and lower profile components forming the multiple levels.

### BRIEF DESCRIPTION OF THE DRAWINGS

These and other features and advantages of the present invention will be better understood by reading the following detailed description, taken together with the drawings wherein:

FIG. 1 is a side schematic view of a fiber transition system, according to one embodiment of the present invention;

FIG. 2 is a perspective schematic view of a fiber transition system, according to one embodiment of the present invention;

FIG. 3 is a side schematic view of a fiber transition system, according to another embodiment of the present invention;

FIG. 4 is a perspective view of a fiber transition apparatus, according to one embodiment of the present invention;

FIG. 5 is a perspective view of a section of a fiber holding member, according to another embodiment of the present invention;

FIG. 6 is a perspective view of a mounting member, according to one embodiment of the present invention;

FIG. 7 is a cross-sectional view of a mounting member, according to another embodiment of the present invention;

FIG. 8 is a cross-sectional view of a mounting member, according to yet another embodiment of the present invention; and

FIG. 9 is a perspective view of a mounting member, according to a further embodiment of the present invention.

### DETAILED DESCRIPTION OF THE PREFERRED EMBODIMENTS

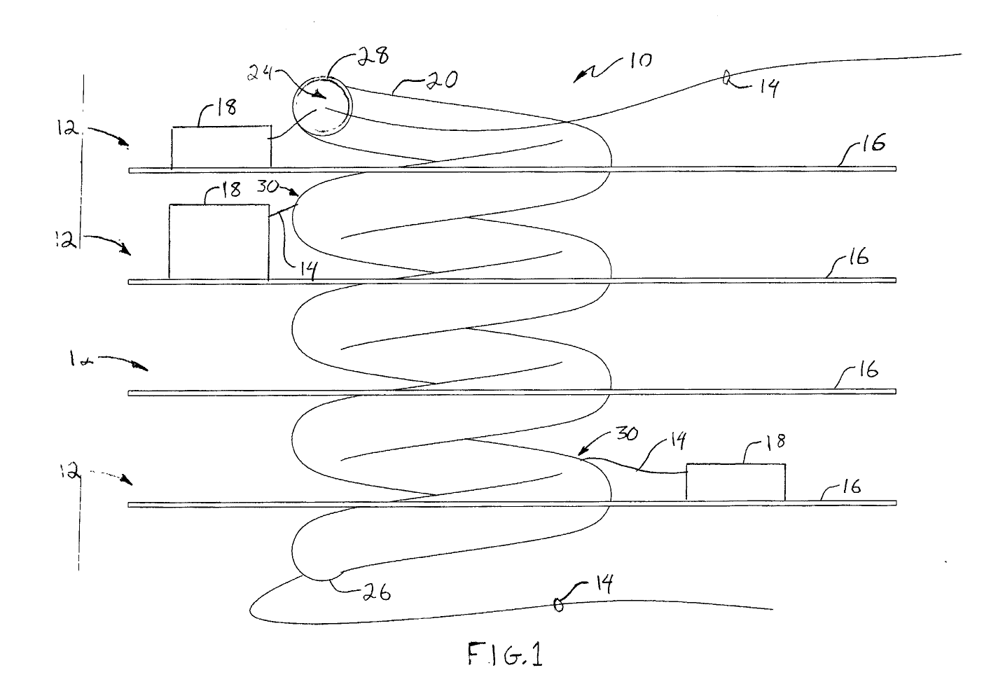

Referring to FIGS. 1-3, a multi-level fiber transition apparatus 10 is shown for use in fiber optic equipment having optical fibers 14 passing through multiple planes or levels 12 of components 18, such as electronic and/or optical components. The multi-level fiber transition apparatus 10 preferably includes a helical fiber holding member 20 that passes through the multiple levels 12 and transitions the optical fibers 14 through the multiple levels 12. The fibers 14 pass from the helical fiber holding member 20 to one or more of the electronic components 18 at the various levels 12. The fiber transition apparatus 10, the optical fibers 14, and the multiple levels 12 of components 18 form a fiber transition system. In one example, the fiber optic equipment includes telecommunications equipment. The fiber transition system can also be implemented in other equipment requiring management and transitioning of optical fibers through multiple levels with substantially continuous protection while maintaining the critical fiber bend radius.

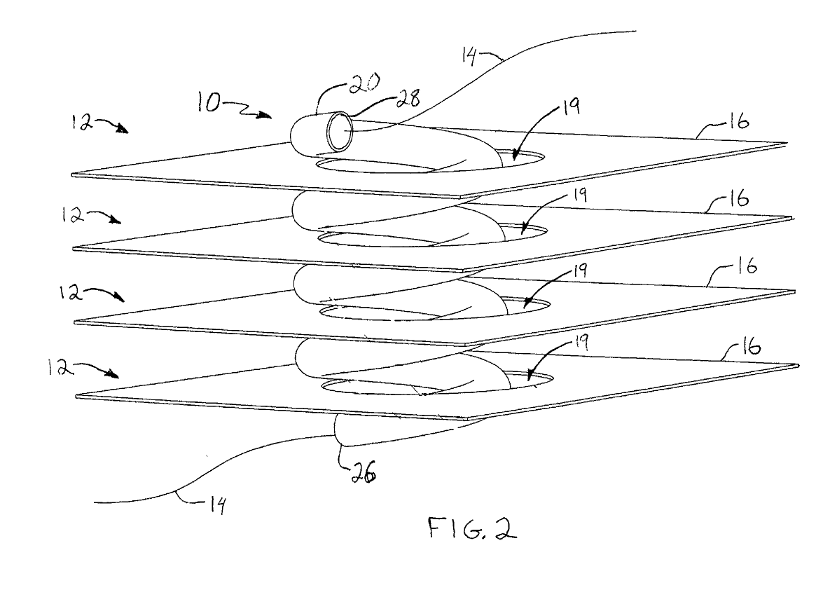

According to one embodiment (FIGS. 1 and 2), the multiple planes or levels 12 are formed by multiple printed wiring boards (PWBs) 16 including one or more components 18. The helical fiber holding member 20 is preferably mounted to one or more of the PWBs 16. Each of the PWBs 16 being traversed by the helical fiber holding member 20 preferably includes a hole 19 (FIG. 2) sized to allow the fiber holding member 20 to pass or thread through. The size of the hole 19 varies depending upon the pitch and size of the helical fiber holding member 20. Although the helical fiber holding member 20 is shown traversing four PWBs 16, the helical fiber holding member 20 can traverse a greater or fewer number of levels 12 or PWBs 16 depending on the application.

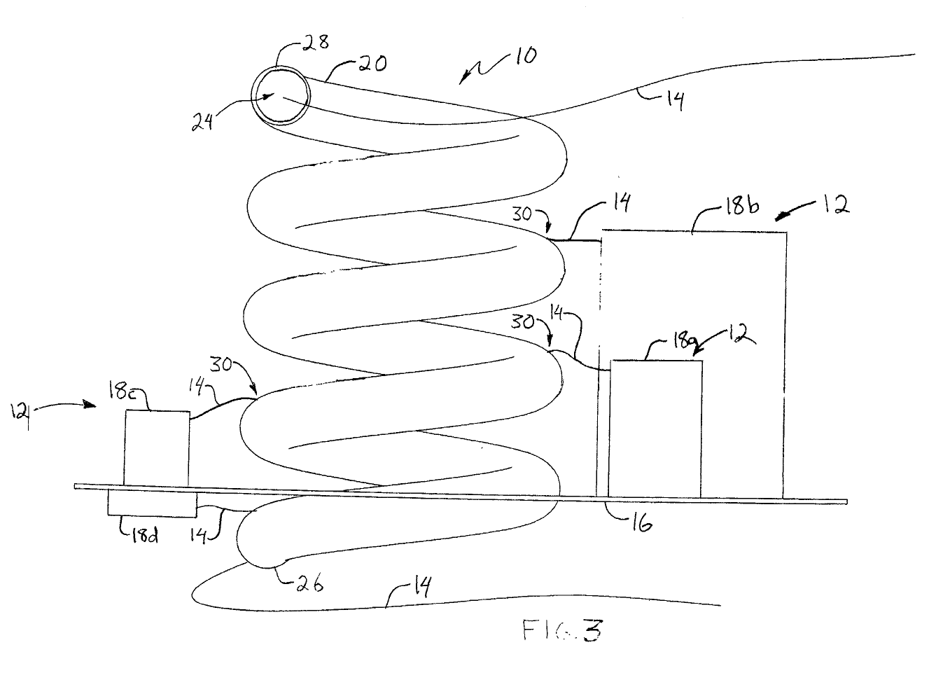

According to an alternative embodiment (FIG. 3), the multiple planes or levels 12 are formed by components 18 of different sizes on a single PWB 16. In this embodiment, the multi-level fiber transition apparatus 10 can be used to elevate the optical fiber 14 from a lower profile optical device 18a to a higher profile optical device 18b. The multi-level fiber transition apparatus 10 can also be used to transition the optical fiber 14 between components 18c, 18d on opposite sides of the PWB 16. The helical fiber holding member 20 is preferably mounted to the PWB 16.

The helical fiber holding member 20 has a fiber passage 24 for receiving the optical fibers 14. The passage 24 preferably extends from a first end 26 to a second end 28 of the helical fiber holding member 20. The helical fiber holding member 20 also includes fiber insertion regions 30 (see FIG. 1) extending through the holding member 20 to the fiber passage 24. The insertion regions 30 are preferably located at least proximate each of the levels to allow selected optical fibers 14 to be added and/or dropped at selected levels for connection to the respective components 18.

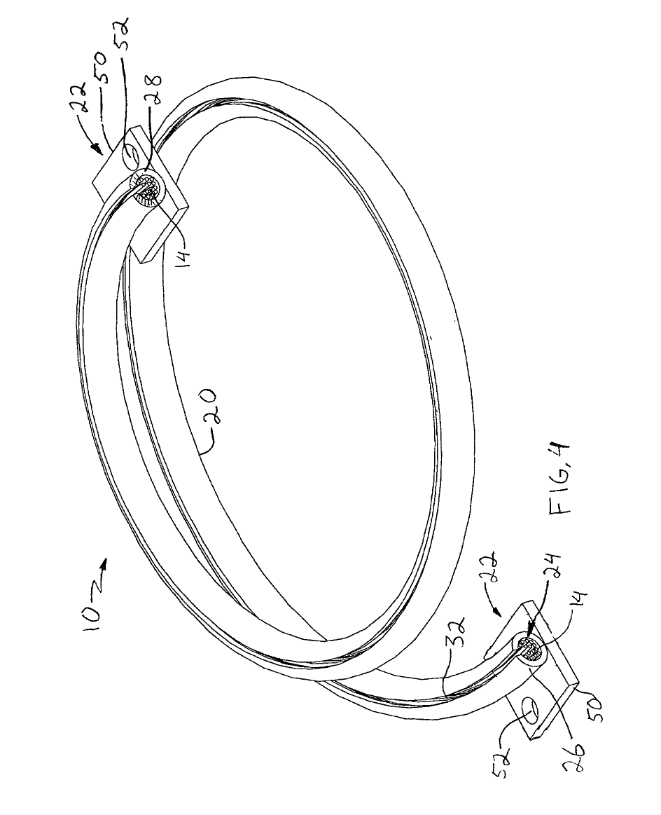

Referring to FIG. 4, one embodiment of the helical fiber holding member 20 includes at least one slot 32 extending along the helical fiber holding member 20 to form the insertion regions 30. In the exemplary embodiment, the slot 32 extends along the entire length of the fiber holding member 20 from the first end 26 to the second end 28. The insertion regions 30 are thus located at any point along the holding member 20.

Alternatively, the slot 32 or multiple spaced slots 32 can extend along only a portion of the fiber holding member 20. For example, an alternative embodiment of the helical fiber holding member 20′, shown in FIG. 5, includes periodic flaps 34 to hold the optical fibers 14 in place in the passage 24. The flaps 34 form multiple slots 32a-d. The flaps 34 are preferably formed as part of the base material of the holding member 20′. For example, the material is die cut with the flaps 34 and then rolled to form the holding member 20′.

The helical fiber holding member 20 has a shape and dimension to maintain the critical bend radius of the optical fibers 14. In one example, the critical bend radius is in the range of about 25 to 30 mm. The helical fiber holding member 20 can be a rigid tube or a flexible tube that has a limited bend radius. In one embodiment, the helical fiber holding member 20 includes a body with a construction similar to that used in strain relief boots used with fiber optic connectors to guarantee the minimum bend radius. One example of this type of construction is disclosed in U.S. Pat. No. 5,915,056, which is fully incorporated herein by reference. The fiber holding member 20 is preferably constructed from a non-flammable and static dissipative material to insure its compliance with safety and manufacturing specifications, respectively. One example of the material is flame retardant Nylon.

According to one embodiment, the multi-level fiber transition apparatus 10 further includes at least one mounting member 22 for mounting the helical fiber holding member 20 to one or more of the PWBs 16. Alternatively, the mounting member 22 can mount the helical fiber holding member 20 to another location within the fiber optic equipment. In one preferred embodiment, mounting members 22 are located at each of the ends 26, 28 of the helical fiber holding member 20 to minimize the real estate needed for mounting and to reduce the assembly cost. Mounting members 22 can also be located at other locations along the fiber holding member 20, for example, at each location where the fiber holding member 20 traverses one of the PWBS 16. These additional mounting members 22 insure mechanical stability under vibration and seismic activities.

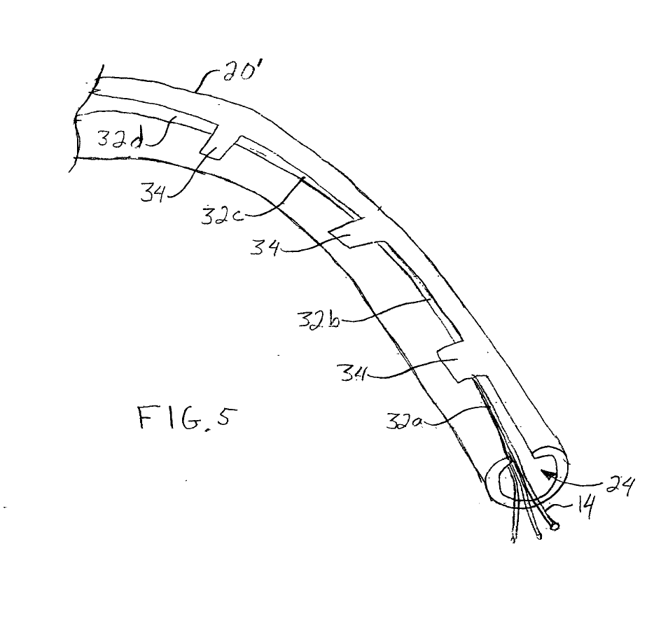

Referring to FIGS. 4 and 6-9, various embodiments of the mounting members 22 are shown. One embodiment of the mounting member 22 designed to mount to a PWB 16 includes a mounting plate 50 having at least one hole 52 for receiving a fastener (FIG. 4). The mounting plate 50 can include multiple holes 52a, 52b (FIG. 6) to prevent rotation when mounted. The mounting plate 50 is either attached to the ends 26, 28 of the fiber holding member 20 (FIG. 4) or built in to the fiber holding member 20 as one piece (FIG. 6).

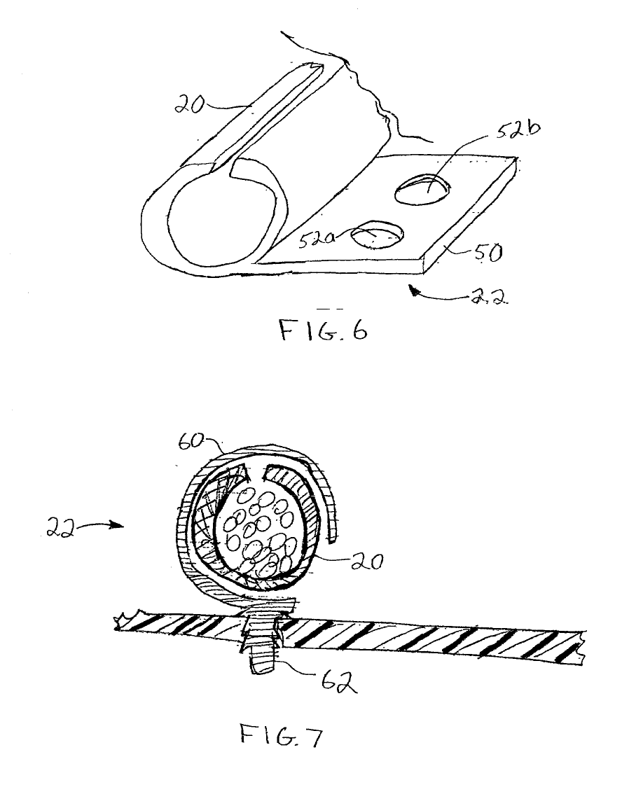

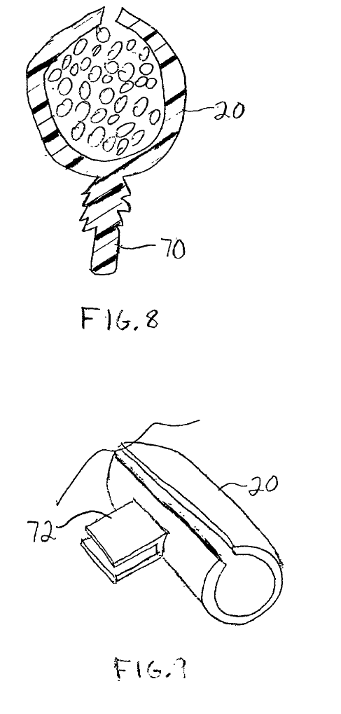

According to another embodiment, the mounting member 22 includes a rounded portion 60 that receives the fiber holding member 20 (FIG. 7). The rounded portion 60 includes a peg 62 that extends into or through the PWB 16. According to a further embodiment, the fiber holding member 20 includes a built in attachment member that attaches to the PWB 16, such as a peg 70 for insertion into the PWB 16 (FIG. 8) or a board clip 72 for clipping onto an edge of the PWB 16 (FIG. 9).

In use, the PWBs 16 are assembled in the electronic equipment and the helical fiber holding member 20 is passed through the holes 19 in the PWBs 16. The helical fiber holding member 20 is mounted within the electronic equipment, for example, at each end 26, 28 to the respective PWBs 16. Optical fibers 14 are passed through the fiber passage 24 from one end 26 to the other end 28 of the helical fiber holding member 20. The slot 32 assists in the insertion of fibers 14 into the fiber holding member 20. Selected fibers 14 can be added and/or dropped at any level as necessary to connect to one or more components 18 at any level. The fibers 14 are thus transitioned between levels using a self-contained single device that maintains the critical bend radius of the optical fibers 14 while also providing jacketed protection to the fibers 14 and efficiently using real estate within the electronic equipment.

Modifications and substitutions by one of ordinary skill in the art are considered to be within the scope of the present invention, which is not to be limited except by the following claims.

The invention claimed is:

1. A multi-level fiber transition apparatus, for use in transitioning optical fiber between multiple levels of components in fiber optic equipment, said multi-level fiber transition apparatus comprising:
a helical fiber holding member having a fiber passage for receiving said optical fiber and insertion regions spaced along said helical fiber holding member for allowing said optical fibers to pass into and out of said fiber passage, wherein said helical fiber holding member has a shape and dimension to maintain a critical bend radius of said optical fiber; and
at least one mounting member for mounting said helical fiber holding member to said fiber optic equipment.

2. The multi-level fiber transition apparatus of claim 1 wherein said fiber passage extends from a first end to a second end of said helical fiber holding member.

3. The multi-level fiber transition apparatus of claim 1 wherein said helical fiber holding member includes at least one slot extending along at least a portion of said helical fiber holding member and into said fiber passage, and wherein said slot forms said insertion regions.

4. The multi-level fiber transition apparatus of claim 3 wherein said helical fiber holding member includes flaps spaced along said fiber holding member and extending over said slot, for holding said optical fibers in said fiber passage.

5. The multi-level fiber transition apparatus of claim 1 wherein said mounting member is positioned at least at one end of said helical fiber holding member.

6. The multi-level fiber transition apparatus of claim 1 wherein said mounting member is positioned at both ends of said helical fiber holding member.

7. The multi-level fiber transition apparatus of claim 1 wherein said mounting member is secured to said helical fiber holding member.

8. The multi-level fiber transition apparatus of claim 1 wherein said mounting member is one-piece with said helical fiber holding member.

9. The multi-level fiber transition apparatus of claim 1 wherein said mounting member is a plate having at least one mounting hole for receiving at least one fastener.

10. The multi-level fiber transition apparatus of claim 1 wherein said mounting member is a peg extending from said helical fiber holding member.

11. The multi-level fiber transition apparatus of claim 1 wherein said mounting member is a board clip extending from said helical fiber holding member.

12. The multi-level fiber transition apparatus of claim 1 wherein said mounting member includes a separate piece for receiving a portion of said helical fiber holding member.

13. The multi-level fiber transition apparatus of claim 1 wherein said helical fiber holding member has a generally tubular shape.

14. A fiber transition system for use in fiber optic equipment, said fiber transition system comprising:
optical fiber;
a helical fiber holding member having a fiber passage receiving said optical fiber and insertion regions spaced along said helical fiber holding member for allowing said optical fibers to pass into and out of said fiber passage, wherein said helical fiber holding member has a shape and dimension to maintain a critical bend radius of said optical fiber; and
multiple levels of electronic components, wherein said helical fiber holding member passes through at least two of said multiple levels and wherein said insertion regions in said helical fiber holding member are located proximate at least two of said multiple levels such that said optical fiber passes through said insertion regions in said helical fiber holding member to said electronic components at respective said at least two of said multiple levels.

15. The fiber transition system of claim 14 wherein multiple printed wiring boards form said multiple levels of electronic components.

16. The fiber transition system of claim 15 wherein said helical fiber holding member is mounted to at least one of said printed wiring boards.

17. The fiber transition system of claim 15 wherein at least some of said multiple printed wiring boards include a hole for receiving said helical fiber holding member.

18. The fiber transition system of claim 14 further including mounting members connected to said helical fiber holding member at least at the ends thereof.

19. The fiber transition system of claim 14 wherein a printed wiring board having higher profile components and lower profile components form said multiple levels of electronic components.

20. The fiber transition system of claim 14 wherein said multiple levels includes more than two levels.
